(19) United States
(12) Patent Application Publication
(10) Pub. No.: US 2014/0231555 A1
(43) Pub. Date: Aug. 21, 2014

(54) METHOD FOR GRINDING MILL MATERIAL AND ROLLER MILL

(71) Applicants: Andre Baetz, Juechen (DE); Michael Keyssner, Angeraue (DE); Joerg Langel, Koeln (DE); Michael Triebs, Duesseldorf (DE)

(72) Inventors: Andre Baetz, Juechen (DE); Michael Keyssner, Angeraue (DE); Joerg Langel, Koeln (DE); Michael Triebs, Duesseldorf (DE)

(73) Assignee: LOESCHE GMBH, Duesseldorf (DE)

(21) Appl. No.: 13/994,428

(22) PCT Filed: Dec. 16, 2010
(86) PCT No.: PCT/EP2010/007706

§ 371 Date: Aug. 1, 2013

(51) Int. Cl. B02C 23/26; B02C 23/08

(52) U.S. Cl. CPC B02C 23/26; B02C 23/08; B02C 2015/002
USPC 241/19; 241/57

(57) ABSTRACT

The invention relates to a method for grinding mill material and to a roller mill and is suited in particular to a finest grinding of relatively hard and dry materials, for example cement clinker and granulated blast furnace slag and also for relatively large roller mills.

In order to avoid mill vibrations due to over-grinding of the mill material and to reduce the specific work requirement as well as increasing the throughput a fine material nozzle is arranged after each grinding roller, from which fine material nozzle an air jet with defined impulse is directed from above onto a fine material concentration zone. The fine material concentration zone is formed directly after the grinding zone of each grinding roller and is virtually free of supplied material to be ground and accumulated on a retention rim region. The fine material blown outwards and upwards is fed to a rising conveying air flow and subsequent classifying process.

The invention relates to a method for grinding mill material according to claim 1 and to a roller mill according to claim 11.

The invention is particularly provided for a finest grinding of relatively hard and dry materials, for example cement clinker and granulated blast furnace slag but also cement raw materials and ores as well as for relatively large roller mills.

Known vertical roller mills, also referred to as roller pan mills, of the LOESCHE type for grinding cement clinker and granulated blast furnace slag which can reach product rates of more than 300 t/h have two or three force-impacted grinding rollers and assigned smoothing rollers for the deaeration of the grinding bed. Grinding rollers and smoothing rollers roll on a grinding track of a rotating grinding pan or a grinding bed formed thereon, whereby the grinding pan can have a diameter of over 4 m to nearly 7 m. The arrangement of smoothing or pre-compaction rollers, also referred to as service rollers, before each grinding roller serves to avoid vibrations in an air-swept vertical roller mill and to ensure the guaranteed throughput (EP 0 406 644 B1, DE 42 02 784 C2).

It is known that mill vibrations can limit the throughput and the fineness due to the materials if there are no other external performance limitations such as for example too small filters, fans or drives of the grinding plant. Particularly in the case of very fine and dry products only an insufficiently high grinding force can be incorporated into the grinding bed due to the mill vibrations even if the mill would allow considerably larger through-puts having regard to strength of the components and design of the hydraulic and mill drive.

The reason for the mill vibrations is obviously a combination of grinding bed properties such as fineness, moisture, bulk density, grain-size distribution, particle shape, internal friction coefficients and hardness, in conjunction with the grinding component geometry such as height of retention rim, roller diameter and roller width as well as mill settings, in particular mass flow, inner circulation, contact pressing (grinding force) and grinding speed (grinding pan rotation speed).

The causal interconnection of the influencing variables is an essential reason for the difficulties in the prediction and fight against the mill vibrations which arise mainly at the performance limit of the mill so that the possibilities for vibration-reducing mill settings are limited.

It is known, particularly in the grinding of dry grinding material, to carry out a water injection in order to optimise the grinding bed and to achieve a reduction in the mill vibrations. Water is thereby sprayed onto the grinding bed (DE 198 06 895 A1) through horizontal lances which are provided with nozzles and are respectively arranged before the grinding rollers. The water has a positive effect upon the internal friction in the grinding bed during the incorporation below the grinding rollers, so that the mill vibrations can be effectively prevented and the throughput of the mill increased. However, the use of water requires evaporation within the mill in order to keep residual moisture low in the finished product. The advantages of the water injection regarding reduced vibrations are cancelled out by the greatly increased furnace thermal capacity for drying. In case of cement mills the use of the water injection also leads to an impairment in the product properties, in particular the strength. In addition water is not available in many areas of the earth in the sufficient quantities or the use of water is even prohibited by law.

It is known that mill vibrations and over-grinding of the supplied material to be ground are directly correlated with each other. In case of roller pan mills the material which is generally supplied centrally must be accumulated contrary to the centrifugal force acting on the grinding pan edge in order to be drawn in by the individual grinding rollers and ground in a grinding zone between the grinding rollers and a grinding track of the grinding pan. In case of roller pan mills of the LOESCHE type the accumulation or retention of the mill material to be ground is achieved on a planar horizontal grinding track by means of a variably adjustable retention rim of a predetermined height and shaping. Without a retention rim on the periphery of the rotating grinding pan the grinding material would leave the grinding pan unhindered and a sufficiently thick grinding bed could not be formed between the grinding rollers and the grinding pan or the grinding track. However, the accumulation of material to be ground, necessary for the mill throughput, simultaneously prevents that the ground material can leave the grinding pan. Completely ground material thus gets once again under a grinding roller and over-grinding takes place which leads to a higher specific energy requirement of the roller mill. As the retention rim required in horizontal planar grinding pans or grinding tracks, leads through its height and shaping to a higher grinding bed and to a longer dwell time of the grinding material on the grinding pan, there are over-grinding procedures. The higher grinding bed causes a spring effect through its higher elasticity which has a negative influence upon the efficiency of the grinding and further increases the tendency towards vibrations in large mills due to the grinding material which is all in all finer on the grinding pan.

It is an object of the present invention to create a method for grinding mill material in a roller mill and a roller mill or roller pan mill with which an over-grinding of the grinding material to be ground and mill vibrations can be extensively prevented and at the same time the specific energy requirement can be reduced.

According to the method the object is achieved through the features of claim 1 and according to the device through the features of claim 11. Useful and advantageous embodiments are described in the sub-claims and in the description of the figures.

A core idea of the invention can be seen in that after each grinding roller the mill material ground to fine material is removed as completely as possible and over-grinding is therefore prevented. As the fine material is removed from the grinding bed and grinding pan or grinding track after each grinding roller and fed to a rising conveying air flow, the grinding bed is modified in a targeted way regarding the grain size distribution. Coarsening of the grinding bed takes place and over-grinding can be eliminated or considerably reduced with the consequence that a considerable increase in the throughput of the roller mill can be achieved.

In the inventive method for grinding mill material in a roller mill, wherein mill material to be ground is fed to a rotating grinding pan provided with a retention rim and ground with the aid of stationary grinding rollers, which roll in a force-impacted manner on a grinding bed formed by the supplied mill material, in a grinding zone between the grinding roller and the grinding pan or grinding track, according to the invention after each grinding roller an air jet with a definable impulse is directed from a fine material nozzle from above onto a fine material concentration zone. The fine material concentration zone is formed directly after the grinding zone of each grinding roller and is extensively free from supplied mill material to be ground. This is fed due to the rotation of the grinding pan on spiral tracks to the grinding rollers but thereby deflected by the face-sides of the grinding rollers, in the “shadow” of which a fine material region can initially form with a fine material concentration zone.

The fine material concentration zone and the area-wise larger fine material region are formed in the vicinity of a retention rim directly after the discharge from a grinding roller and thus directly adjacent to the grinding zone of each grinding roller. As the fine material is blown out and upwards of the fine material concentration zone with the aid of at least one air jet of a fine material nozzle it reaches a rising conveying air flow which is fed through a louvre ring arranged between the grinding pan and the mill housing for pneumatic conveyance of the fine material and feeding to a classification process of the mill.

An essential feature is the orientation of the air jet or the fine material nozzle onto the formed fine material concentration zone directly after the grinding zone of each grinding roller and on the retention rim region so that the fine material is blown outwards and upwards before mixing with the freshly supplied mill material takes place and over-grinding is carried out by the next grinding roller. The fine material is blown out essentially from a relatively small triangle, seen in top view, directly behind the grinding zone of each grinding roller and bordered by the retention rim.

Impacting the ground material with air after each grinding roller with the aid of a nozzle-like device is known from DE 33 11 433 A1. However, the ground mill material is thereby shot with air from a nozzle opening of a hollow scraper which is arranged at a small distance above and transversely to the grinding track in order to separate the ground mill material broken up by the scraper and the fine material particles from the coarse material in order that these can be taken along by the conveying air flow from the louvre ring. The known method is directed to a classification of the ground mill material over the whole width of the grinding track after each grinding roller, whereby the coarse fraction is to once again fall completely back to the grinding table and be ground again. Additionally, the powerful shot of air against a layer of the ground material takes place from below after the grinding material layer has been raised by the scraper. Through the shot of air from below and a first classification of the grinding material over the whole width of the grinding table for removal of sufficiently reduced fine material from the grinding table a lower energy requirement is to be achieved for the grinding process and a reduced pressure drop in the conveying air.

In contrast to this known shot of air, in the inventive method a fine material nozzle is directed from above onto a fine material concentration zone which is extensively free of freshly fed material to be ground.

Through trials on a laboratory roller mill it has been ascertained that when using fine material nozzles according to the invention the specific work requirement can be considerably reduced. A reduction in the specific work requirement of approximately 20% with a nozzle pre-pressure of 1 bar was ascertained in comparative trials. The tests have shown in principle that with the aid of the fine material nozzles and air jets directed in a defined way, in particular from above, fine material can be blown out and over-grinding and mill vibrations can thereby be prevented or considerably reduced.

By blowing the fine material locally out of a fine material concentration zone directly behind each grinding roller a reduction in the mill vibrations and simultaneously a reduction in the specific work requirement on the grinding pan by approximately 20% can be guaranteed without any other intervention being necessary in the construction and process technology of the mill.

It is advantageous that using the inventive fine material nozzles the height of the retention rim on the grinding pan periphery and the specific energy requirement can be decoupled in process terms. Higher retention rims can now be used for the purpose of increasing the throughput without disadvantages for the energy requirement on the grinding pan.

A further advantage consists in that the mill material coarsened through the removal of the fine material can be ground without increasing vibrations with a higher working pressure so that the milling progress increases. The inner circulation thereby reduces and the differential pressure decreases so that the throughput of the roller mill can also be increased in this way.

The air jets from the fine material nozzles are advantageously set regarding mass flow and speed corresponding to the respective requirements. Due to the adjustability the grinding bed can be locally modified in a targeted way and the whole grinding process can be positively influenced.

The adjustability of the fine material nozzles and outgoing air jets can take place with respect to an inclination angle and a blow-out angle so that optimisation of the fine material blow-out and thus of the grinding bed can be achieved. Inclination angles and blow-out angles are defined by the fine material concentration zone and the outlet region of the fine material nozzles and are explained further in connection with the description of the drawings. The air jets from the fine material nozzles can usefully be set and changed regarding the mass flow and speed, wherein the speed can have a value in the range of between 10 m/s and the sonic velocity of the gas used, whereby specially formed nozzles can be used for this (Laval nozzles).

It lies within the scope of the invention to not only feed compressed air via a compressed air line outside of the roller mill to the fine material nozzles but instead also to direct other gases or also vapour via the fine material nozzles onto the fine material concentration zones of the individual grinding rollers and to blow the fine material outwards and upwards.

In a corresponding construction of the fine material nozzles the air, gas or vapour jets can be supplied with a temperature which has a value in the range of between −50° C. and 800° C. Gases at low temperatures can be used for example in order to artificially embrittle materials which are ductile at room temperature and vapours of higher temperatures can be suited to local conditioning of ground material for subsequent processes in a targeted way.

An inventive roller mill which is constructed in a per se known way as an air-swept roller mill or roller pan mill and comprises a rotating grinding pan with a virtually horizontal grinding track and a retention rim on the grinding pan edge is provided with fine material nozzles according to the invention. The fine material nozzles are arranged in such a way that an air jet is respectively directed from above onto a fine material concentration zone directly after each grinding roller and on an adjacent retention rim region and blows the fine material accumulated here upwards and feeds it to the rising conveying air flow.

Through the inventively directed fine material nozzles onto a defined relatively small region directly after a grinding roller and on a retention rim region the fine material is blown upwards before fresh grinding material deflected from the face side of the rollers can mix with the fine material or can lie on top of this fine material.

It is useful to design the fine material nozzles which are arranged behind each grinding roller to be angle adjustable in order that the fine material leaving the roller gap between a grinding roller and the grinding pan can be swirled up and blown upwards through the respectively adjustable air jet. The whole of the fine material or at least large portions of the fine material produced can then be supplied from the conveying air leaving a louvre ring with relatively high speed and can be pneumatically transported upwards to a classifier.

It is advantageous that the fine material nozzles are respectively directed onto the fine material concentration zone, in which the majority of the fine material arising during the grinding is collected or accumulated through the retention rim. It is thereby possible in an extraordinarily efficient manner to remove the fine material and at the same time achieve an optimisation of the grinding bed for the purpose of preventing mill vibrations.

It has been ascertained through trials that it is useful to arrange the fine material nozzles with at least one nozzle opening for an outgoing air jet at a defined distance from the reducing zone of each grinding roller. The distance can have a value in the range of from 200 to 1200 mm and is essentially dependent upon the form of the fine material nozzles.

If the fine material nozzles comprise an outlet region with at least one nozzle opening for the outgoing air jet and a feed region which extends from the mill housing radially via the grinding track and with a distance above the grinding bed or a fine material region and/or the fine material concentration zone, the outlet region with the nozzle opening can be directed downwards and outwards in the direction of the retention rim region and onto the fine material concentration zone.

It has been found in laboratory tests with a laboratory mill that air with a pre-pressure (primary pressure) in the nozzle ring line outside of the mill housing of approximately 0.5 bar to approximately 1.5 bar, in particular approximately 1 bar, can be supplied. In large plants the volume flows are higher and the pressures lower.

The fine material nozzles can have in principle any form and be designed for example as round jet nozzles or flat nozzles. In addition they can be designed with one or multiple jets and the use of a plurality of nozzles with the same or different angular adjustment is also possible.

An alternative air supply to the individual fine material nozzles comprises a line which leads for example radially into the centre of the roller mill for the whole air flow provided for the fine material nozzles. In the centre of the roller mill, usefully within an oversize material cone, a distribution device can be arranged, from which even air flows or gas flows or flows of another medium can be distributed via lines, for example branch lines, to the individual fine material nozzles.

Due to the central arrangement of the distribution device a flow enhancing line arrangement to the fine material nozzles in rotationally symmetrical form is possible.

It is particularly advantageous that a roller mill provided with the inventive fine material nozzles can be used for difficult to grind mill materials or mill materials to be ground very finely, wherein due to the desired fineness a high retention rim must be used. An inventive roller mill is preferably used for the grinding of cement clinker, granulated blast furnace slag and also for very hard cement raw materials and ores.

Besides the advantages already described, it is achieved through the inventive orientation of the fine material nozzles that only fine material is swirled up and blown out. The coarse particles or coarser fractions are not captured by the fine material nozzles as the fine material nozzles are directed onto a defined region and swirl up the fine material present in a high concentration.

Through the inventive orientation of the fine material nozzles a transport of the fine material takes place outwardly into the rising air flow from the louvre ring so that an effective transport to the classifier is guaranteed.

A further advantage consists in that the fine material nozzles are not subject in principle to any wear as there is no direct contact with the mill material on the grinding pan.

An essential advantage lies in the decoupling in process technology of the retention rim height and energy requirement, whereby the retention rim can also be increased without disadvantageous consequences for vibrations and energy requirements in the interests of a maximum throughput. It is thus possible to use smaller mills for the same mill throughputs, whereby this is in turn associated with lower investment and operating costs.

The invention is explained in further detail below by reference to a drawing, in which the following are shown in a greatly schematised illustration:

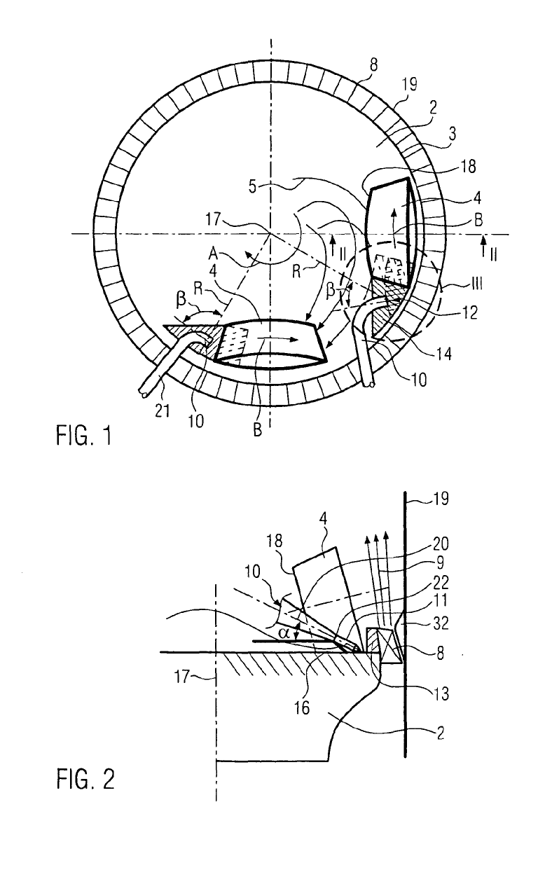

FIG. 1 a top view of a grinding pan with an inventive roller mill;

FIG. 2 a view along the line II-II in FIG. 1;

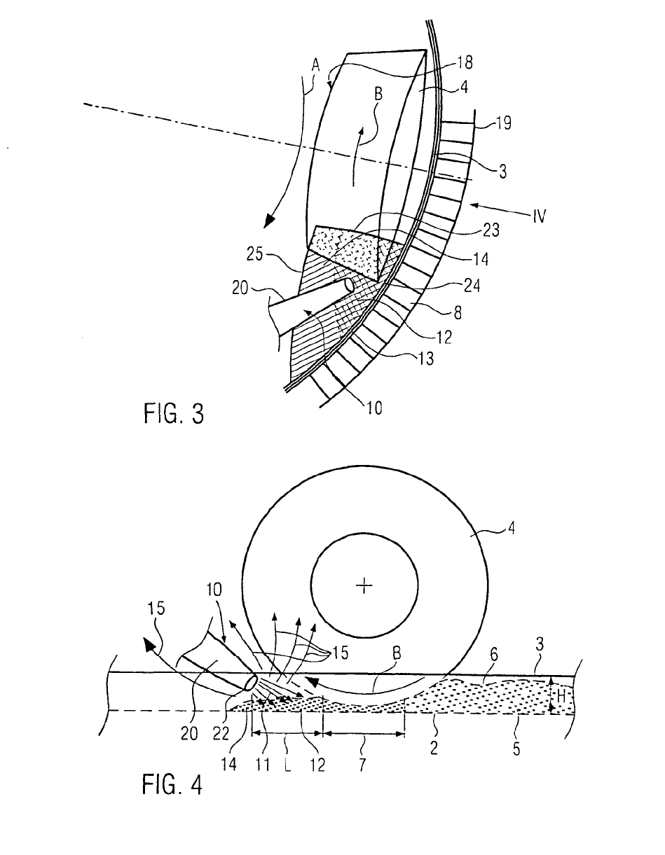

FIG. 3 an enlargement of the cut-out III in FIG. 1; and

FIG. 4 a view according to arrow IV in FIG. 3; and

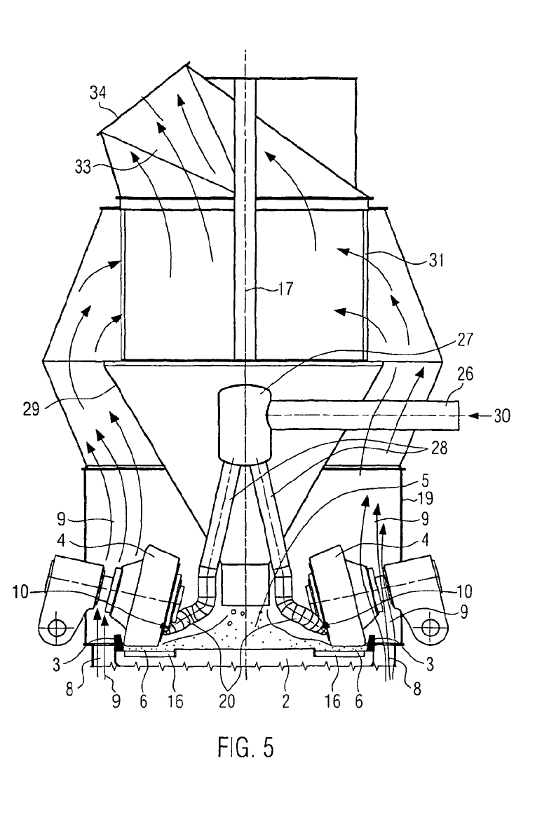

FIG. 5 a vertical section through an inventive roller mill with an alternative air supply.

FIG. 1 shows a grinding pan 2 of an inventive roller mill which rotates according to arrow A about a longitudinal axis 17. The grinding pan 2 is provided on its periphery with a retention rim 3, the height H and shaping of which follow in an exemplary manner from FIGS. 2 and 4.

In this example four hydraulically pressed grinding rollers 4 run on the grinding pan 2 with the surrounding and co-rotating retention rim 3, whereby only two grinding rollers 4 are shown in FIG. 1. In principle between two and eight grinding rollers can be used. By rotating the grinding pan 2 the centrally fed mill material 5 to be ground is supplied on spiral tracks to the grinding rollers 4 and drawn inwards in a gap between the grinding rollers 4 and grinding pan 2 respectively grinding track 16 and ground in a grinding zone 7 (see FIG. 4).

Through the retention rim 3 the supplied and ground mill material 5 is accumulated and held on the grinding pan 2. Sufficiently reduced fine material 15 lies directly after the grinding zone 7 (FIG. 4) in a fine material region 14 which is shown in hatching in FIG. 1 and has the form of an acute-angled triangle, of which the base line 23 is formed by the boundary of the grinding zone 7, and of which the outer limb 24 limits the fine material region 14 (see FIG. 3). The inner limb 25 of the triangle is formed by an extension of a face side 18 of the respective grinding roller 4. The fine material region 14 is also shown in hatching in the enlargement of FIG. 3. FIG. 3 further illustrates a second, smaller triangle region within the fine material region 14 and this smaller region is a fine material concentration zone 12, which is shown in double hatchings.

A fine material nozzle 10 with an outlet region 20 and a nozzle opening 22 for an air jet 11 is respectively directed onto the fine material concentration zone 12 in which the directly ground fine material is accumulated (see also FIGS. 2 to 4).

FIGS. 2 and 4 in particular show that the fine material nozzle 10 is directed with the outlet region 20 and the nozzle opening 22 from above onto the fine material concentration zone 12, whereby the fine material 15, still before fresh grinding material can lie on top of it, is blown out and fed to a conveying air flow 9 (FIG. 2) which is supplied by a louvre ring 8, and can be transported pneumatically upwards to a classifier (not shown).

The fine material 15 in the fine material concentration zone 12 and also in the fine material region 14 is virtually free of fresh grinding material, as this—particularly as follows from FIG. 1—is deflected from the face side 18 of the assigned grinding roller 4 and is only then drawn in by the following grinding roller 4.

The direction of rotation of the grinding rollers 4 rolling on the grinding pan 2 or respectively the grinding bed 6 is indicated by the arrow B. Arrow A shows the direction of rotation of the grinding pan 2.

FIG. 1 shows the construction of the fine material nozzles 10 which are guided through a mill housing 19 or from the mill housing 19 with a tubular feed line region 21 approximately radially inwards and at a distance from the grinding bed 6 and with an angled down outlet region 20 orientated downwards in the direction of the grinding bed 6 (see also FIGS. 2 and 4). The supply of the air or the gas can also take place from the centre of the mill outwardly to the fine material nozzles.

The nozzle opening 22 of the fine material nozzle 10 is formed circularly in the embodiments. The outlet region 20 is formed according to FIG. 2 with an angle of inclination a relative to the grinding pan 2. The angle of inclination a can be between 15° and 110°.

In FIG. 2 the angle of inclination a is approximately 45°, whereby the air jets 11 are directed onto a corner region between the grinding track 16 and retention rim region 13.

FIG. 4 shows the outward and upward blowing of the fine material 15 and the space respectively distance L between the end of the grinding zone 7 of the grinding roller 4 and the nozzle opening 22 of the assigned fine material nozzle 10. The fine material 15 is blown out of the fine material concentration zone 12 upwards and reaches the conveying air flow 9 (FIG. 2) which leaves from the louvre ring 8 between the grinding pan 2 and mill housing 19 and is inwardly deflected by an armoured bulge 32 on the mill housing 19. The pneumatic transport of the upwardly blown fine material 15 upwards and in the direction of a classifier 31 (see FIG. 5) is thereby facilitated.

FIG. 3 illustrates with the enlarged illustration of a grinding roller 4 the size relationships of the fine material concentration zone 12, onto which the angularly adjustable fine material nozzle 10 with the nozzle opening 22 on the outlet region 20 is respectively directed, in a relationship to the fine material region 9.

FIG. 4 shows the height H of the retention rim 3 on the periphery of the grinding pan 2, the formation of a grinding bed 6 on the grinding pan 2 and the incorporation region and the grinding zone 7 between grinding roller 4 and grinding pan 2.

FIG. 1 shows with the two fine material nozzles 10 after a respective grinding roller 4 the blow-out angle β, by which the outlet region 20 is angled down from the virtually radial feed region 21. The blow-out angle β is encompassed with the longitudinal axis of the outlet region 20 and a radial R of the grinding pan 2 which is guided through the nozzle opening 22.

FIG. 5 shows an inventive roller mill which is formed as an air-swept roller mill and has an alternative air supply. A classifier 31 is integrated into the roller mill and a fine material-air mixture 33 is discharged via a fine material discharge while coarse particles (not shown) pass via an oversize material cone 29 back to the grinding pan 2 and are again subjected to the grinding process.

The whole air flow 30 provided for the fine material nozzles 10 is fed via a feed line 26 which can be orientated for example radially in the direction towards the centre of the mill, to a distribution device 27 and via branch lines 28 which advantageously extend evenly from the distribution device 27, to the individual fine material nozzles 10.

FIG. 5 shows that the distribution device 27, for example a distributor receptacle, is arranged in the centre of the oversize material cone 29 and that the branch lines 28 are downwardly orientated and are provided on the end face with the outlet region 20 and the nozzle opening 22 of the fine material nozzles 10. The central supply of the entire air flow 30 for the fine material nozzles 10 facilitates a flow-enhancing line arrangement in rotationally symmetrical form. The branch lines 28 can penetrate on the lower part into the wall of the oversize material cone 29 and be fixed to it.

It is pointed out that the elements of the air supply in FIG. 5 are not true to scale but have instead been illustrated larger than the usual components of the air-swept roller mill in order to allow better recognition.

1. Method for grinding mill material in a roller mill,
wherein mill material to be ground (5) is fed to a rotating grinding pan (2) provided with a retention rim (3) and is ground by means of stationary grinding rollers (4), which roll in a force impacted way on a grinding bed (6) formed by the supplied mill material (5), in a grinding zone (7) and
the ground material (5) is impacted after each grinding roller (4) with air from a nozzle-like device and fine material is blown out and fed to a conveying air flow (9) rising from a louvre ring (8) between grinding pan (2) and mill housing (19) and to a classifying process,
characterised in that
a fine material nozzle (10) is used as nozzle-like device and an air jet (11) with defined impulse is directed from above onto a fine material concentration zone (12) which is formed directly after the grinding zone (7) of each grinding roller (4) extensively free of supplied mill material (5) to be ground and accumulated on a retention rim region (13), and
the fine material (15) is blown out of the fine material concentration zone (12) with the aid of the air jet (11) from the fine material nozzle (10) and upwards into the rising conveying air flow (9).

2. Method according to claim 1,
characterised in that
the fine material (15) blown upwards with the aid of the air jets (11) from the fine material nozzles (10) and fed to the conveying air flow (9) is deprived of an over-grinding.

3. Method according to claim 1 or 2,
characterised in that
the air jets (11) of the fine material nozzles (10) are adjusted in relation to mass flow and speed.

4. Method according to one of the preceding claims,
characterised in that
the fine material nozzles (10) are respectively directed with an outlet region (20) for the air jet (11) onto the fine material concentration zone (12) and the adjacent retention rim region (13).

5. Method according to one of the preceding claims,
characterised in that
the fine material nozzles (10) are adjusted at least with an outlet region (20) in relation to the grinding pan (2) and/or in relation to a radial R of the grinding pan (2).

6. Method according to claim 5,
characterised in that
the fine material nozzles (10) are directed with their outlet region (20) with an angle of inclination a which lies in the range of between 15° and 110° onto the fine material concentration zone (12) and the retention rim region (13).

7. Method according to claim 5,
characterised in that
the fine material nozzles (10) are directed with their outlet region (20) in relation to the radial R with a blow-out angle β which has a value in the range of between 10° and 110° in relation to the fine material concentration zone (12) and the retention rim region (13).

8. Method according to one of the preceding claims,
characterised in that
the speed of the air jets or gas jets leaving the fine material nozzles (10) is adjusted to a value in the range of between 10 m/s and sonic velocity of the gas used.

9. Method according to one of the preceding claims,
characterised in that
instead of air jets gas or vapour jets are directed from the fine material nozzles (10) onto the fine material concentration zone (12) and the retention rim region (13) of the grinding rollers (4) and the fine material (15) is blown upwards.

10. Method according to one of the preceding claims,
characterised in that
air, gas or vapour jets are used with a temperature in the range of between −50° C. and 800° C. for blowing out the fine material (15).

11. Roller mill
comprising a mill housing (19), a rotating grinding pan (2) with a virtually horizontal grinding track (16) and a retention rim (3) and
stationary, hydraulically pressable grinding rollers (4) which roll on a grinding bed (6) formed on the grinding track (16) by supplied mill material (5) to be ground and grind the mill material (5) in a grinding zone (7) between grinding roller (4) and grinding track (16),
a vane ring (8) between the grinding pan (2) and the mill housing (19) for supplying a rising conveying air flow (9) for the pneumatic transport of fine material (15) to a classifier and
nozzle-like devices for impacting the grinding bed (6) with air, which nozzle-like devices are arranged after each grinding roller (4), in particular for carrying out the method according to one of the claims 1 to 10,
characterised in that
fine material nozzles (10) are arranged as nozzle-like devices and are directed so that a respective air jet (11) is directed from above onto a fine material concentration zone (12) directly after each grinding roller (4) and on a retention rim region (13) and blows the accumulated fine material (15) upwards into the rising conveying air flow (9).

12. Roller mill according to claim 11,
characterised in that
the fine material nozzles (10) comprise an outlet region (20) with at least one nozzle opening (22) for an air jet (11) and a feed region (21),
the feed region (21) extends from the mill housing (19) radially at least partially over the grinding track (16) and is arranged at a distance above the grinding bed (6) with a fine material region (14) and the fine material concentration zone (12) and
the outlet region (20) is orientated with the nozzle opening (22) downwards and outwards in the direction of the retention rim (3) or retention rim region (13) and onto the fine material concentration zone (12). (FIG. 1).

13. Roller mill according to claim 11 or 12,
characterised in that
a nozzle ring line is arranged outside of the mill housing (10), from which air or another medium, for example gas or vapour, can be fed to the fine material nozzles (10) via their feed region (21).

14. Roller mill according to claim 11,
characterised in that
the fine material nozzles (10) comprise an outlet region (20) with at least one nozzle opening (22) for an air jet (11),
the outlet region (20) is formed respectively on the end side on branch lines (28) which extend from a distribution device (27) and
the distribution device (27) is arranged centrally above the grinding pan (2) and connected to a feed line (26) for the whole air flow (30) to be distributed onto the fine material nozzles (10). (FIG. 5).

15. Roller mill according to claim 14,
characterised in that
the distribution device (27) is formed as a distribution receptacle and is arranged within an oversize material cone (29).

16. Roller mill according to claim 14 or 15,
characterised in that
the branch lines (28), but at least the outlet region (20) of the fine material nozzles (10), are designed to be adjustable and are orientated downwards and outwards in the direction of the retention rim (3) or retention rim region (13) and onto the fine material concentration zone (12).

17. Roller mill according to one of the claims 14 to 16,
characterised in that
the branch lines (28), but at least of the outlet region (20) of the fine material nozzles (10), have a flow encouraging rotationally symmetrical construction.

18. Roller mill according to one of the claims 12 to 17,
characterised in that
the fine material nozzles (10) are arranged with a predefinable angle of inclination α and/or blow-out angle β after each grinding roller (4), wherein the angle of inclination α is encompassed respectively by the longitudinal axis of the outlet region (20) and the grinding track (16) and the blow-out angle β by the longitudinal axis of the outlet region (20) and a radial R of the grinding pan (2) which is guided through the nozzle opening (22) (FIGS. 1 and 2).

19. Roller mill according to one of the claims 11 to 18,
characterised in that
the height of the retention rim (3) on the periphery of the grinding pan (2) can be varied in dependence upon the blow-out of the fine material (15) from the fine material concentration zones (12) after the grinding rollers (4).

20. Roller mill according to one of the claims 11 to 19,
characterised in that
the fine material nozzles (10) for blowing out the fine material concentration zones (12) are arranged with their nozzle opening (22) respectively at a distance L from the reduction zone (7) and the distance L has a value in the range of between 200 and 1200 mm.

21. Roller mill according to claims 11 to 20,
characterised in that
the fine material nozzles (10) are designed as round jet nozzles, flat nozzles or nozzles of any form and cross-section as well as having one or more jets.

22. Roller mill according to one of the claims 11 to 21,
characterised in that
the fine material nozzles (10) are designed for compressed air, gases or vapours with temperatures in the range of from −50° C. to 800° C.

23. Roller mill according to one of the claims 11 to 22,
characterised by
the feeding of difficult to grind mill material or mill material to be ground very finely, for example cement, granulated blast furnace slag, very hard cement raw materials or ores and a relatively high retention rim (3) on the periphery of the grinding pan (2).
